(19) United States
(12) Patent Application Publication
(10) Pub. No.: US 2007/0030693 A1
(43) Pub. Date: Feb. 8, 2007

(54) Convex luminant sign

(76) Inventor: Dennis Karlsson, Alingsas (SE)

Correspondence Address: MANELLI DENISON & SELTER, 2000 M STREET NW SUITE 700, WASHINGTON, DC, 20036-3307, US

(21) Appl. No.: 10/551,134

(22) PCT Filed: Apr. 1, 2004
(86) PCT No.: PCT/SE04/00498

§ 371 Date: Sep. 29, 2005

(30) Foreign Application Priority Data
Apr. 2, 2003 (SE) 0300982-6

(51) Int. Cl. F21V 7/04

(52) U.S. Cl. 362/605; 362/613; 362/628

(57) ABSTRACT

The present invention relates to an electric sign comprising an front side (2), a rear side (4) and at least one side surface (5, 6, 15) that extends between and links together the front side (2) and the rear side (4), where a light guiding interior of a transparent material is comprised between said front side (2), rear side (4) and side surface (5, 6, 15), a lighting appliance (8) being arranged in connection with said side surface (5, 6, 15) in order to emit light to the light guiding material, and the rear side (4) being adapted to comprise figures (3) reflecting the light from the lighting appliance (8), through the front side (2) of the electric sign, characterised in that the front side (2) of the electric sign (1) is convex.

### TECHNICAL FIELD

The present invention relates to an electric sign comprising an front side, a rear side and at least one side surface that extends between and links together the front side and the rear side, where a light guiding interior of a transparent material is comprised between said front side, rear side and side surface, a lighting appliance being arranged in connection with said side surface in order to emit light to the light guiding material, and the rear side being adapted to comprise figures reflecting the light from the lighting appliance, through the front side of the electric sign.

### PRIOR ART

Banderol-like transparent signs with figures in the form of text, images or patterns, that appear to be luminous are sometimes used for advertising purposes, for lighting, for information at e.g. exhibitions, or for pure decoration. The signs are manufactured from a light guiding, transparent material and are lighted up by one or more light sources in connection with at least one of the sides of the electric sign. The figures are applied to the rear side of the sign, in a manner known to the skilled person. Electric signs of this type are known from DE 201 18 930, DE 43 41 015, US 2001/0049893, GB 2 139 796 and U.S. Pat. No. 5,276,591.

For strength reasons, these electric signs have a fairly limited size. If larger sizes are required, the electric sign is often provided with a structural frame. The structural frame also prevents unwanted leakage of light along the sides of the electric sign.

A need also exists for cantilever banderol-like signs, for which it is desired not to provide the sign with a structural frame. For strength reasons such signs have a rectangular cross-section, where the thickness of the sign must be increased in proportion to the length and width of the sign. The edges of the electric sign are sealed with paint or mirror-glass foliation, in order to prevent unwanted leakage of light along the sides of the sign.

Yet another disadvantage is that the figures applied on the rear side are visible only within a fairly narrow viewing angle, which means that the figures will have the most distinct appearance when the viewer is positioned essentially straight in front of the sign. If the viewer on the contrary is positioned by the side of the sign or at another level, the visibility is considerably impaired.

### BRIEF ACCOUNT OF THE INVENTION

It is an object of the present invention to eliminate or at least minimize the above mentioned problems, and this is achieved by providing an electric sign with a convex front side of the light guiding, transparent material.

Thanks to the invention, an electric sign is obtained that offers a considerably improved viewing angle as compared to electric signs having a planar front side. Furthermore, an optical magnification is obtained of the figures applied on the rear side, which enhances visibility.

By a electric sign according to the invention, one or more of the following advantages can furthermore be obtained.
Improved strength
Possibility to make larger cantilever signs
Possibility to give the electric sign a curved shape
No sealing required to prevent unwanted leakage of light

The invention is primarily intended for small size electric signs, to be used as bearers of information or for advertising or decoration purposes, where the viewer is positioned within some tenths of metres from the electric sign. Such electric signs have a size of from a few square centimetres, e.g. 0.5×2 cm as an illuminated emblem on a small detail such as some type of domestic electronics, and up to some square metres as bearer of information in public environments. One example of this is a rod-shaped electric sign that is used to mark out and illuminate an emergency exit route, where the electric sign can be a continuous illuminated rod having a length of several metres and a width of 5-20 cm. It should however be understood that other sizes and other fields of application are comprised in the invention.

### BRIEF DESCRIPTION OF THE DRAWINGS

In the following, the invention will be described in greater detail with reference to the attached drawing figures, of which:

FIG. 1 shows in perspective a preferred embodiment of the light guiding material in a sign,

FIG. 2 shows an electric sign in a front view,

FIG. 3a shows a cross-section of a transparent rod,

FIG. 3b shows a view from above of a transparent rod,

FIG. 4a shows a cross-section of two combined, transparent rods,

FIG. 4b shows a cross-section of three combined, transparent rods,

FIG. 5a shows an alternative embodiment of an electric sign,

FIG. 5b shows a cross-section of a double-sided electric sign,

FIG. 6a shows an alternative embodiment of an electric sign, and

FIG. 6b shows an alternative embodiment of an electric sign.

### DETAILED DESCRIPTION OF THE INVENTION

The present invention relates to an electric sign intended to be a stand-alone sign or mounted on a wall or an object.

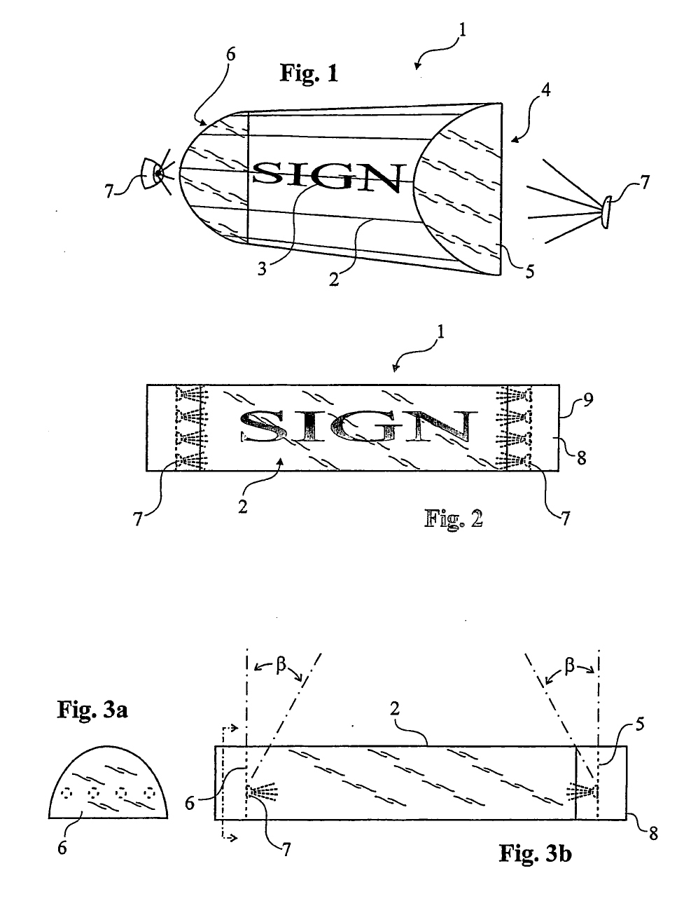

FIG. 1 shows in perspective an electric sign 1 in a preferred embodiment. In this embodiment, the light guiding, transparent material has the shape of a continuous rod with a convex front side 2. The sign has a rear side 4 on which figures 3 have been applied in any manner known to the skilled person. Light-emitting elements 7, schematically shown, are arranged in connection with at least one side surface 5, 6 of the rod.

FIG. 2 shows an electric sign in a front view. Here, the continuous rod 1 with its convex front side 2 is shown with a lighting appliance 8 in connection with both side surfaces. The lighting appliance 8 comprises the light-emitting elements 7, here as a number of light-emitting diodes. As in this case, the rod may be provided with some type of recesses, e.g. drilled holes or grooves, for countersinking of the light-emitting elements 7 a short distance into the light guiding material. The lighting appliance 8 also comprises a casing 9 that is arranged to closely encase the side surface 5, 6 in order to prevent leakage of light via said side surface.

FIGS. 3a and 3b show a cross-section and a view from above, respectively, of the electric sign. The electric sign is preferably designed such that it admits the casing 9 to conceal the light-emitting elements 7, at least along the front side 2 of the electric sign and at a view from the front of the electric sign. In a preferred embodiment, the light-emitting elements 7 are concealed to the viewer also when he is positioned at a location where a viewing angle (β) between said location and the side surface 5, 6 is at least 15°, preferably at least 30° and even more preferred at least 45°.

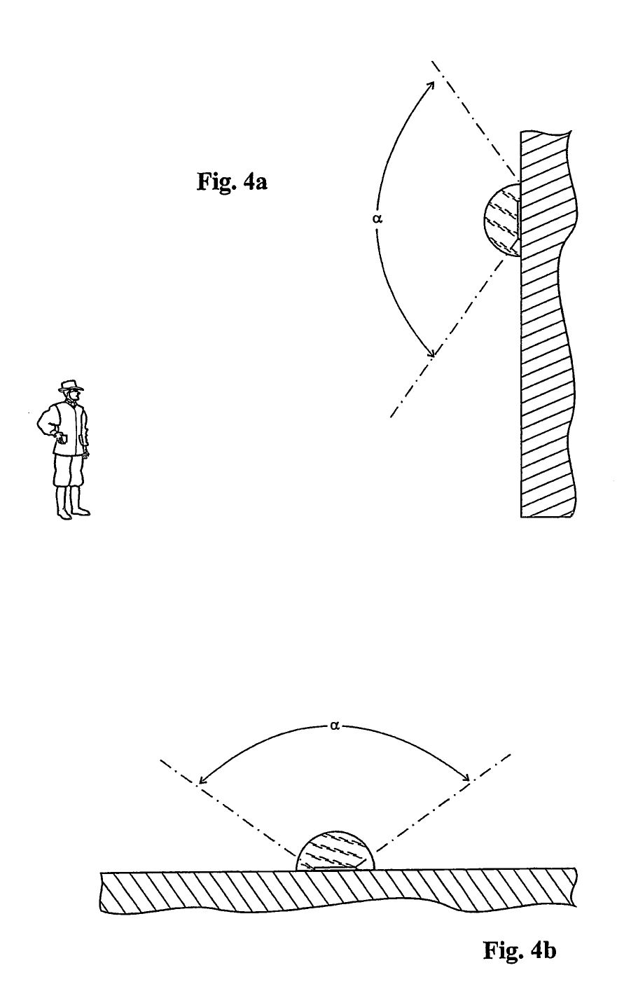

By the convex shape of the front side 2, the advantage is attained that the figures 3 are clearly visible from very large radial viewing angles (α), which is illustrated in FIGS. 4a and 4b.

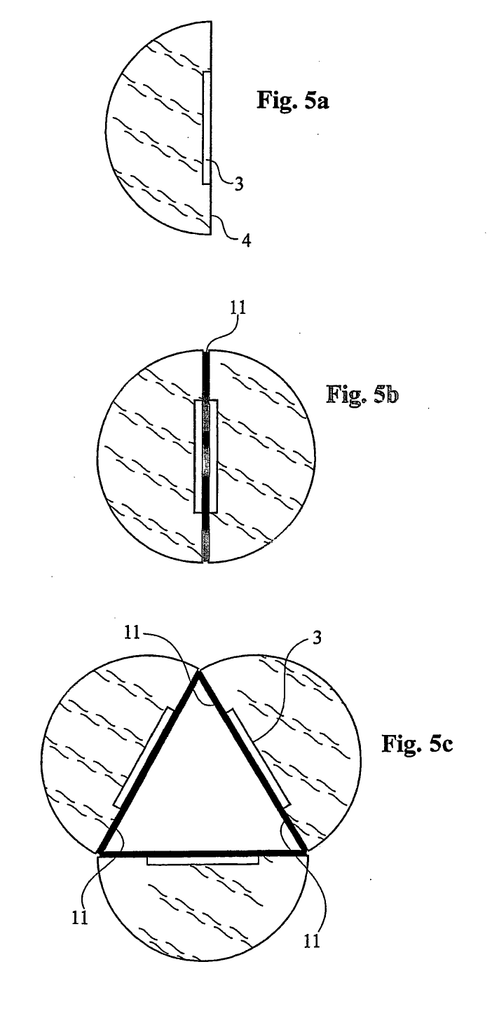

FIG. 5a shows a cross-section of an electric sign 1 in the form of a transparent, light guiding rod according to a preferred embodiment of the invention. It should be understood that the rear side 4 need not be completely planar. Of course, the convex front side 2 can be given another bend radius than the one shown. As in this case, the figures 3 can be in the form of light-reflecting ribs/grooves at the rear side 4, but the skilled person will realise that this is only one example and that other ways of applying the figures also are comprised in the invention. For example, printed stickers or foil may have been brought into contact with the rear side. The figures can also be painted directly onto the rear side.

In addition to larger viewing angles, an optical magnification of the figures 3 is obtained. The viewing angel and the optical magnification are both dependent of the bend radius of the convex surface. In the preferred embodiment, the electric sign is given such a bend radius that a cross-section of the transparent material, i.e. a section parallel to a side surface 5, 6 is given the shape of a semi circle. Also elliptical shapes are conceivable, but the height between the rear side and the convex front side 2, this height being measured perpendicular to the rear side 4 in the point in which the convex front side 2 has its maximum, is preferably at least ¼, even more preferred ⅓ of the radial length of the rear side.

FIG. 5b shows a cross-section of a double electric sign consisting of two combined, transparent rods. If it is desired to have an electric sign with a text that can be read from both sides, two convex rods can be attached to each other with an intermediate, non-transparent barrier layer 11. Furthermore, the skilled person will realise that several rods can be placed in juxtaposition, so that each sign unit comprises for example three rods in the form of a triangular sign or four rods in the form of a rectangular sign, where triangular and rectangular, respectively, refers to the space enclosed by the rear sides of the rods, se FIG. 5c.

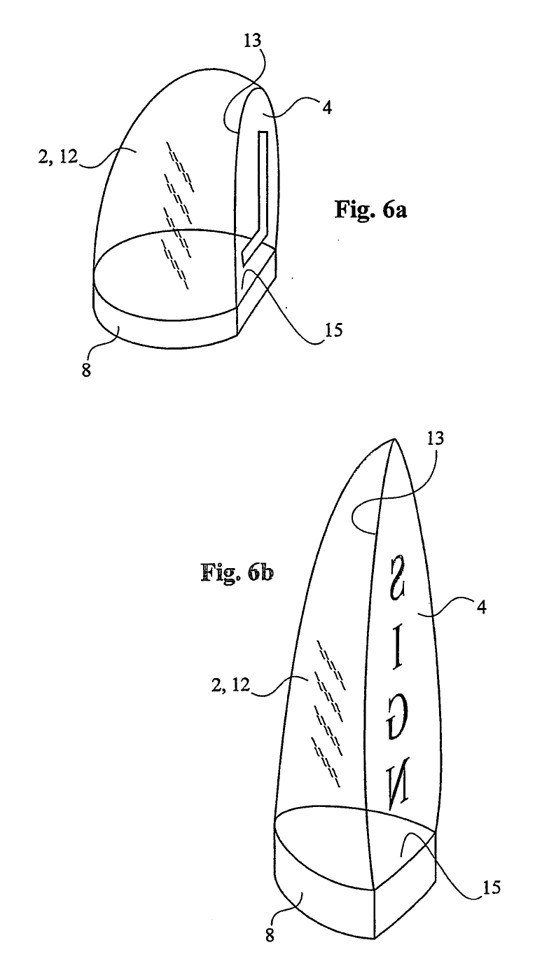

FIG. 6a shows an alternative embodiment of an electric sign according to the invention. As is apparent, this does not have the shape of a rod, but is characterised in that the light guiding material has the shape of a split sphere 12. The lighting appliance 8 is arranged along a side surface 15 of the split sphere 12, and accordingly the convex front side 2 is in direct contact with the rear side 4 along a main part of the outside edge 13 of the rear side.

FIG. 6b shows yet an alternative embodiment

It is realised that thanks to the design of the light guiding material, where the convex front side 2, apart from the portion along the side surface/surfaces 5, 6, is in direct communication with the rear side 4, the electric sign need not anywhere a conventional coating with a light impervious or light-reflecting coating or be provided with an enclosing frame to prevent unwanted leakage of light. Thanks to the design, an electric sign is also obtained that is of cantilever design, which means that it need not be provided with a structural element. Furthermore, it is realised that the electric sign can be given a varied shaped. Accordingly, electric signs are also comprised in which the light guiding material can be given different geometrical shapes, at a view from the front, but in which the front side 2 is given a convex shape.

1-7. (canceled)

8. An electric sign comprising a front side, a rear side and at least one side surface that extends between and links together the front side and the rear side, where a light guiding interior of a transparent material is comprised between said front side rear side and side surface, a lighting appliance being arranged in connection with said side surface in order to emit light to the light guiding material, and the rear side being adapted to comprise figures reflecting the light from the lighting appliance, through the front side of the electric sign, wherein the front side of the electric sign is convex.

9. An electric sign according to claim 8, wherein the convex front side at least partly is in direct communication with the rear side.

10. An electric sign according to claim 9, wherein the sign has a bend radius that results in a height between the rear side and the convex front side, the height (h) being measured perpendicular to the rear side in a point in which the convex front side has its maximum.

11. An electric sign according to claim 10, wherein the height (h) is at least ¼ of the radial length of the rear side.

12. An electric sign according to claim 10, wherein the height (h) is at least ⅓ of the radial length of the rear side.

13. An electric sign according to claim 8, wherein the sign comprises two opposing side surfaces, in that the front surface extends between these side surfaces, and in that the front surface along the side of the electric sign that extends between the two opposing side surfaces is in direct communication with the rear side.

14. An electric sign according to claim 13, wherein the sign has the shape of a rod.

15. An electric sign according to claim 8, wherein the lighting appliance comprises a casing and at least one light-emitting element arranged inside the casing, and in that the casing is arranged to closely enclose the side surface in order to prevent leakage of light via said side surface.

16. An electric sign according to claim 15, wherein the light-emitting element is positioned inside the casing in such a way that the casing, at least along the front side of the electric sign, conceals the light-emitting element at a view of the electric sign from a location at which a viewing angle (v) between said location and the side surface is at least 15°.

17. An electric sign according to claim 16, wherein the viewing angle (v) between said location and the side surface is at least 30°.

18. An electric sign according to claim 16, wherein the viewing angle (v) between said location and the side surface is at least 45°.

19. An electric sign according to claim 9, wherein the lighting appliance comprises a casing and at least one light-emitting element arranged inside the casing, and in that the casing is arranged to closely enclose the side surface in order to prevent leakage of light via said side surface.

20. An electric sign according to claim 10, wherein the lighting appliance comprises a casing and at least one light-emitting element arranged inside the casing, and in that the casing is arranged to closely enclose the side surface in order to prevent leakage of light via said side surface.

21. An electric sign according to claim 13, wherein the lighting appliance comprises a casing and at least one light-emitting element arranged inside the casing, and in that the casing is arranged to closely enclose the side surface in order to prevent leakage of light via said side surface.

22. An electric sign according to claim 14, wherein the lighting appliance comprises a casing and at least one light-emitting element arranged inside the casing, and in that the casing is arranged to closely enclose the side surface in order to prevent leakage of light via said side surface.
